(19) United States
(12) Patent Application Publication
(10) Pub. No.: US 2026/0235275 A1
(43) Pub. Date: Aug. 13, 2026

(54) LIGHTING SOURCE

(71) Applicant: SAVANT TECHNOLOGIES LLC, East Cleveland, OH (US)

(72) Inventors: Kun XIAO, Shanghai (CN); Jie GAO, Shanghai (CN); Xuda LI, Shanghai (CN)

(73) Assignee: SAVANT TECHNOLOGIES LLC, East Cleveland, OH (US)

(21) Appl. No.: 19/358,858

(22) Filed: Oct. 15, 2025

(30) Foreign Application Priority Data
Oct. 25, 2024 (CN) 202411505453X

(51) Int. Cl. F21V 9/32; F21Y 115/10

(52) U.S. Cl. CPC F21V 9/32; F21Y 2115/10

(57) ABSTRACT

Provided is a lighting source that includes a light-emitting diode and a fluorescent gel for packaging the light-emitting diode, the fluorescent gel having a phosphor and a silica gel composition mixed with the phosphor, the light-emitting diode is a blue light chip, and the phosphor includes a first red phosphor with a full width at half maximum of less than 60 nm and a second red phosphor with a full width at half maximum of more than 60 nm, the weight ratio of the first red phosphor to the second red phosphor is greater than 4:1, and the phosphor also includes at least one yellow or yellow-green phosphor, and an emission wavelength of the blue light chip is 420 nm to 480 nm.

### CROSS-REFERENCE TO RELATED APPLICATIONS

This application claims priority to Chinese Patent Application Serial Number 202411505453X, filed Oct. 25, 2024, which is herein incorporated by reference.

### TECHNICAL FIELD

The present disclosure relates to the field of lighting, and in particular, to a lighting source having enhanced chromatographic characteristics, such that an observer can perceive enhanced colors.

### BACKGROUND

Currently, in the field of lighting, it has been found that users prefer colors with enhanced saturation to make colors more attractive. To this end, a light source may emit light having enhanced spectral features, such that the users perceive enhanced colors. Attempts have been made to combine two or more color indexes to design the spectrum of the lighting source, so as to achieve optimal color preference.

However, although existing lighting sources have good color rendering or color preference, these lighting sources may have problems such as poor light-emitting efficiency, short service life, and high cost, etc. These existing techniques provide generally-acceptable performance, but it is still desirable to further enhance the light-emitting efficiency, color quality, or reduce manufacturing costs of the lighting sources.

Therefore, the present disclosure is intended to propose a lighting source using an optimized phosphor recipe, so as to ameliorate the defects existing in the prior art.

### SUMMARY OF THE INVENTION

In view of this, the present disclosure is intended to propose a lighting source using an optimized phosphor recipe. Compared with lighting sources in the prior art, said lighting source achieves further improvements in terms of lighting preference index (LPI), color rendering index (CRI) and luminous efficacy LPW, such that a user perceives enhanced color preference, thereby further improving the sales volume of illumination devices comprising the lighting source and reducing costs.

According to one aspect of the present disclosure, provided is a lighting source, comprising a light-emitting diode and a fluorescent gel for packaging the light-emitting diode, the fluorescent gel comprising a phosphor and a silica gel composition mixed with the phosphor; wherein the light-emitting diode is a blue light chip, and an emission wavelength of the blue light chip is 420-480 nm; the phosphor comprises a first red phosphor with a full width at half maximum (FWMH) of less than 60 nm and a second red phosphor with a full width at half maximum (FWMH) of greater than 60 nm, and at least one yellow or yellow-green phosphor; wherein the weight ratio of the first red phosphor to the second red phosphor is greater than 4:1.

In this way, the lighting source of the present disclosure uses an optimized phosphor recipe, wherein the first red phosphor is a narrow-band red phosphor, and the second red phosphor is a broad-band red phosphor. By making the weight ratio of the narrow-band red phosphor to the broad-band red phosphor greater than 4:1, the lighting preference index (LPI), the color rendering index (CRI) and the luminous efficacy LPW of the lighting source are all significantly improved, that is, the spectral features of the lighting source are enhanced, and the manufacturing cost of the lighting source is reduced.

According to exemplary embodiments of the present disclosure, the lighting preference index (LPI) of the lighting source is at least 110, and the color rendering index (CRI) thereof is at least 80.

In this way, LPI is a lighting preference index, and quantitative optimization of color preference is achieved by adjusting the spectral power distribution of the lighting source. The LPI may be used as a quantitative metric to provide a design rule, so as to maximize the color preference characteristics of the lighting source, and/or to design spectral multi-response optimizations including color preferences and other photometric, colorimetric, and other design responses.

According to exemplary embodiments of the present disclosure, the greater the weight ratio of the first red phosphor to the second red phosphor is, the greater the lighting preference index of the illumination light source is, the greater the color rendering index is, and the greater the luminous efficacy LPW is.

In this way, when the weight ratio of the first red phosphor to the second red phosphor becomes greater, the lighting preference index of the lighting source may become higher. This is because increasing the content of the red phosphor will make the spectrum of the lighting source closer to natural light, improving people's comfort and acceptance for the lighting source. In addition, a combination of the first red phosphor and the second red phosphor at a greater weight ratio can further increase the color rendering index of the lighting source. The color rendering index is an index for evaluating the ability of a lighting source to restore the colors of an object, and a higher color rendering index means that the lighting source can restore the actual colors of the object more accurately. In addition, a combination of the red phosphors at a greater weight ratio may also facilitate increase of the luminous efficacy LPW (a ratio of luminous flux to power). The luminous efficacy LPW is an index for measuring the energy efficiency of a lighting source, and a higher luminous efficacy LPW represents a lighting source capable of generating more luminous flux per unit of energy consumption.

However, due to the limitation of a manufacturing process and the limitation of the cost of the narrow-band red phosphor, the weight ratio of the narrow-band red phosphor to the broad-band red phosphor is limited to be greater than 4:1. This ratio can ensure increased lighting preference index, color rendering index and luminous efficacy at a low cost.

According to exemplary embodiments of the present disclosure, in the range of 600 nm to 640 nm, the greater the peak emission wavelength of the second red phosphor is, the greater the lighting preference index is.

In this way, the standard for distinguishing narrow-band red phosphor from broad-band red phosphor is explicitly defined. In spectroscopy, full width at half maximum (FWHM) refers to the width of a peak, and is commonly used to describe the resolution and purity of spectral peaks.

According to exemplary embodiments of the present disclosure, the first red phosphor comprises manganese-doped potassium fluorosilicate (PFS), the second red phosphor comprises nitride red powder, and the yellow or yellow-green phosphor comprises aluminate-series yellow or yellow-green phosphor (YAG, GaYAG, and LuAG) and silicate-series yellow or yellow-green phosphor.

In this way, the phosphor included in the lighting source can achieve a higher light-emitting effect and color saturation. The manganese-doped potassium fluorosilicate (PFS) is a common red phosphor material, and has a good light-emitting effect; the nitride red powder is also a common phosphor material, and is widely applied in LED lighting and display technologies, and has an excellent red light-emitting effect and high color saturation; and the yellow or yellow-green phosphor usually uses silicate or aluminate as a base material, and these materials have good light-emitting performance and stability, and can be used to prepare yellow or yellow-green phosphor with high brightness and high efficiency.

According to exemplary embodiments of the present disclosure, the emission peak wavelength of the yellow or yellow-green phosphor is 520-545 nm.

According to exemplary embodiments of the present disclosure, the lighting source has a correlated color temperature (CCT) in a range of 2500K to 3200K.

In this way, compared with a lighting source formed from NdFO powder, the lighting source has a higher lighting preference index (LPI) and luminous efficacy LPW. The lighting preference index (LPI) is an index for measuring the comfort degree and satisfaction degree of people with regard to a lighting environment, and the luminous efficacy LPW is an index for measuring the energy efficiency performance of a lighting source. The lighting source can combine advantages of various lighting sources, achieve a better illumination effect, and improve people's comfort and working efficiency.

According to another aspect of the present disclosure, provided is a lighting source, comprising a light-emitting diode and a fluorescent gel for packaging the light-emitting diode, the fluorescent gel comprising a phosphor and a silica gel composition mixed with the phosphor; wherein the light-emitting diode is a blue light chip, and an emission wavelength of the blue light chip is 420-480 nm; the phosphor comprises at least one red phosphor with full width at half maximum (FWMH) of less than 60 nm; and the phosphor comprises at least one yellow or yellow-green phosphor having an emission peak wavelength of 520 nm-545 nm.

In this way, the lighting source of the present disclosure further increases the lighting preference index, color rendering index, and luminous efficacy by defining the narrow-band red phosphor and the peak emission wavelengths of the yellow or yellow-green phosphor.

In this way, the lighting preference index is further increased.

According to exemplary embodiments of the present disclosure, in the range of 525 nm to 545 nm, the greater the peak emission wavelength of the yellow or yellow-green phosphor is, the greater the color rendering index of the lighting source is, and the greater the luminous efficacy LPW is.

In this way, while ensuring a high lighting preference index, the color rendering index and the luminous efficacy of the lighting source are further increased.

According to another aspect of the present disclosure, provided is a lighting device, comprising the described lighting source.

In this way, the lighting device comprising the described lighting source can provide an illumination effect favored by users, and has a low cost; therefore, the sales volume of the illumination device is increased.

According to exemplary embodiments of the present disclosure, the lighting device is of a lamp bead type or a filament type.

Embodiments of the present disclosure provide a technical solution of a lighting source using an optimized phosphor recipe, so as to at least solve the technical problems of low lighting preference index, low luminous efficacy and high cost of lighting sources in the prior art, such that the lighting source and the lighting device have the technical effects of enhanced color preference, high luminous efficacy and low cost.

### BRIEF DESCRIPTION OF THE DRAWINGS

Drawings illustrated herein are used for providing further understanding of the present disclosure and constitute a part of the present disclosure, and the illustrative embodiments of the present disclosure and illustrations thereof are used for explaining the present disclosure, rather than constitute inappropriate limitation on the present disclosure. In the drawings:

FIG. 1 is a schematic diagram illustrating a lighting device applying a lighting source of the present disclosure.

FIG. 2 is a schematic diagram illustrating a comparison between spectral features of a lighting source of the present disclosure and spectral features of an existing lighting source.

FIG. 3 shows a table and a graph illustrating the effect of the weight ratio of a narrow-band red phosphor and a broad-band red phosphor of a lighting source according to a first embodiment of the present disclosure on the lighting preference index (LPI) and the color rendering index (CRI).

FIG. 4 shows a table and a graph illustrating the effect of the wavelength of a broad-band red phosphor of a lighting source according to a second embodiment of the present disclosure on the lighting preference index.

FIG. 5 shows a table and a graph illustrating the effect of the wavelength of a yellow or yellow-green phosphor of the lighting source according to the second embodiment of the present disclosure on the lighting preference index and the color rendering index.

### DETAILED DESCRIPTION

Hereinafter, embodiments of the present application will be described in detail with reference to the accompanying drawings, such that a person skilled in the art could easily implement the embodiments of the present application. The present application may, however, be embodied in many different forms, and should not be construed as limited to the embodiments set forth herein. In the drawings, parts irrelevant to the illustration of the present application will be omitted for clarity. Similar reference numerals refer to similar elements throughout the illustration. In addition, when the illustration with reference to the drawings is provided, although elements are denoted by the same numeral, the reference numerals involving the elements may be changed; and the reference numerals are illustrated only for convenience of illustration, and should not be understood as limiting the concept, features, functions, or effects of the elements.

Currently, low-cost, high-efficiency and color-enhanced lighting devices are increasingly favored by users in the market. To further improve the market acceptance of lighting devices, attempts have been made to combine two or more color indexes to better describe color preference.

The present disclosure mainly improves the color quality of a lighting device from aspects such as a lighting preference index (LPI), color rendering index (CRI) and luminous efficacy (LPW), etc., so as to achieve a higher lighting preference index, color rendering index and luminous efficacy at a low cost.

The lighting preference index LPI is a new quantitative and validated color preference metric. The LPI may be used as a quantitative metric to provide a design rule, so as to maximize the color preference characteristics of the lighting source, and/or to design spectral multi-response optimizations including color preferences and other photometric, colorimetric, and other design responses. The resulting spectra, light sources and lamps exhibit high LPI values, which exhibit significantly higher color preferences than existing lighting sources and/or similar conventional products.

The LPI is determined by the following equations:

$$LPI = 100 + 50 \times ( 0.38 \times Whiteness + 0.62 \times Color Appearance )$$

$$LPI = 100 + 19 \times ( 1 - 100 \sqrt{{( Duv + 0.01 )}^{2}} ) + 0.62 \times ( NSV - \frac{HDV}{2.5} )$$

$$Whiteness Color Appearance$$

where Duv describes a distance between illumination white light and a blackbody radiation curve, uv refers to a U coordinate and a V coordinate in a chromaticity diagram; NSV is a net saturation value of the lighting source; and HDV is a hue distortion value.

In addition, the whiteness of the lighting source can also be preliminarily judged by observing the colors of light emitted by the lighting source with naked eyes, but this method is not accurate enough.

Since the whiteness usually needs to be determined through market research, the LPI value cannot be increased by increasing the whiteness.

In view of this, the LPI value can be increased by improving the color appearance, that is, the LPI value is increased by an optimized phosphor recipe.

The color rendering index (CRI) is an important parameter for describing the ability of a lighting source to restore the true colors of an object. CRI is typically used to assess the degree of restoration of light emitted by a lighting source to objects of different colors, i.e. the color restoration capability of the lighting source. The value range of the CRI is 0 to 100, and the higher the numerical value is, the better the color restoration capability of the lighting source is.

The calculation of the CRI is based on the difference between the light emitted by the lighting source and ideal blackbody radiation spectrum emitted by the lighting source. A lighting source with a high color rendering index can better restore true colors of an object, such that the colors of the object are more bright and natural. However, a lighting source with a low color rendering index may cause the colors of the object to deviate, thereby affecting the visual effect and color recognition capability.

The luminous efficacy LPW is an important parameter for describing the energy utilization efficiency of a lighting source, and is generally represented by lumens per unit (Im). The luminous efficacy generally refers to the ratio between the luminous flux generated by the light emitted by the lighting source and electric power consumed. The unit of measurement of the luminous efficacy is lumens per watt (lm/W), which represents the luminous flux generated per watt of electric power.

High luminous efficacy means that the lighting source can convert electrical energy into light energy more efficiently, thereby reducing energy waste. The increase of the luminous efficacy helps to reduce energy consumption and reduce energy costs, and also helps to reduce environmental pollution and reduce greenhouse gas emissions. Therefore, when selecting a lighting source, in addition to considering factors such as color expression and brightness, etc. of the lighting source, the luminous efficacy of the lighting source should also be focused on; and a lighting source with a high luminous efficacy is selected, so as to increase the energy utilization efficiency and reduce the energy consumption.

The present disclosure provides a lighting source using an optimized phosphor recipe, and the lighting source can be applied to a filament-type illumination device or a lamp bead-type illumination device, which is not limited in the present disclosure.

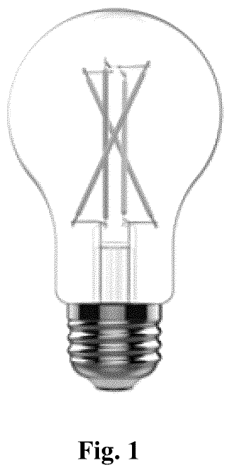

As shown in FIG. 1, a lighting source with an optimized phosphor recipe is applied to a filament-type bulb by mixing a phosphor into a glass housing of a bulb or coating same around the filament inside the bulb.

In one embodiment of the present disclosure, the lighting source comprises a light-emitting diode and a fluorescent gel for packaging the light-emitting diode, the fluorescent gel comprising a phosphor and a silica gel composition mixed with the phosphor; wherein the light-emitting diode is a blue light chip, and an emission wavelength of the blue light chip is 420 nm to 480 nm; the phosphor comprises a first red phosphor with a full width at half maximum (FWHM) of less than 60 nm and a second red phosphor with a full width at half maximum (FWHM) of more than 60 nm, wherein the weight ratio of the first red phosphor to the second red phosphor is greater than 4:1; the phosphor further comprises at least one yellow or yellow-green phosphor.

The fluorescent gel is a material for packaging an LED, and mainly functions to scatter and convert light rays, thereby improving the uniformity and brightness of the light rays. The fluorescent gel is generally formed by combining phosphor with silica gel, in which the phosphor can emit light of a specific color, and the silica gel has good light transmittance and high-temperature resistance, and can effectively protect LEDs.

Full Width at Half Maximum (FWHM) of a spectrum is an important parameter for describing the linear width of the spectrum. In spectral analysis, the full width at half maximum refers to the width of a spectral curve at half the height of a peak, i.e. from one side of the peak to the other side, such that the height of the spectral curve is reduced to half the height of the peak, and the width thereof is the full width at half maximum.

The full width at half maximum is used to describe the distribution width and peak sharpness of the spectral curve. If the full width at half maximum of the spectral curve is narrow, it indicates that the spectral distribution is relatively concentrated and the peak is sharp; on the contrary, if the full width at half maximum is wide, it indicates that the spectral distribution is relatively wide and the peak is gentle.

In practical applications, the full width at half maximum of a spectrum can be used to assess the color purity of a lighting source and the width of the spectral distribution.

In addition, the narrow-band red phosphor NBR comprises manganese-doped potassium fluorosilicate, and the broad-band red phosphor BBR comprises nitride red powder.

In this embodiment, the weight ratio of the narrow-band red phosphor NBR to the broad-band red phosphor BBR is set to be greater than 4:1.

In general, the greater the weight proportion of the narrow-band red phosphor NBR in the lighting source is, the higher the LPI and CRI of the lighting source are. However, due to the limitation of the existing manufacturing process and the limitation of the cost of the narrow-band red phosphor, the weight proportion of the narrow-band red phosphor NBR in the lighting source is at most 40%, and the weight ratio of the narrow-band red phosphor NBR to the broad-band red phosphor BBR is set to be greater than 4:1.

The lighting source has a correlated color temperature (CCT) in a range of 2500K to 3200K. The correlated color temperature (CCT) refers to the color temperature of the lighting source, and is usually expressed in unit of Kelvin (K). The color temperature CCT is an index for describing the color temperature of white light emitted from the lighting source, and is used for indicating the degree of warmth and coldness of the lighting source. Generally, a lighting source with a low color temperature CCT value will exhibit a warmer color, while a lighting source with a high color temperature CCT value will exhibit a cooler color. Common color temperatures of white light are 2700K (warm white light), 4000K (natural white light), 6500K (cool white light), etc. In the field of lighting, the correlated color temperature (CCT) is an important parameter, and can help users to select suitable lighting products to meet different requirements.

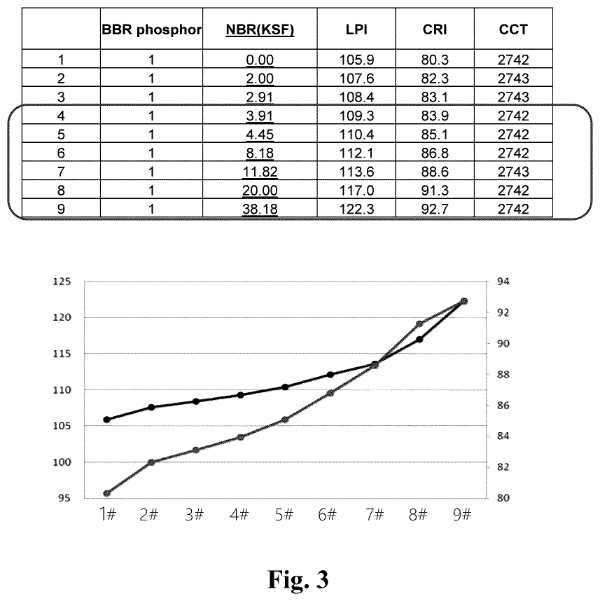

FIG. 3 shows a table and a graph illustrating the effect of the weight ratio of a narrow-band red phosphor and a broad-band red phosphor of a lighting source according to a first embodiment of the present disclosure on the lighting preference index (LPI) and the color rendering index (CRI).

As shown in FIG. 3, in the upper table and the lower line chart, when the weight ratio of the narrow-band red phosphor NBR to the broad-band red phosphor BBR is greater than 4:1, and when the weight proportion of the narrow-band red phosphor in the lighting source does not exceed 40%, the LPI is greater than 110, and the CRI is greater than 80.

The greater the weight ratio of the narrow-band red phosphor NBR to the broad-band red phosphor BBR is, the greater the LPI, CRI, and luminous efficacy LPW of the lighting source are.

The LPI and LPW of the lighting source are higher than the LPI and LPW of a lighting source formed from NdFO powder. For example, the LPI of the lighting source in the present disclosure is 110-120, and the LPI of an existing lighting source is 108; and the LPW of the lighting source of the present disclosure is 124, and the LPW of the existing lighting source is 76.

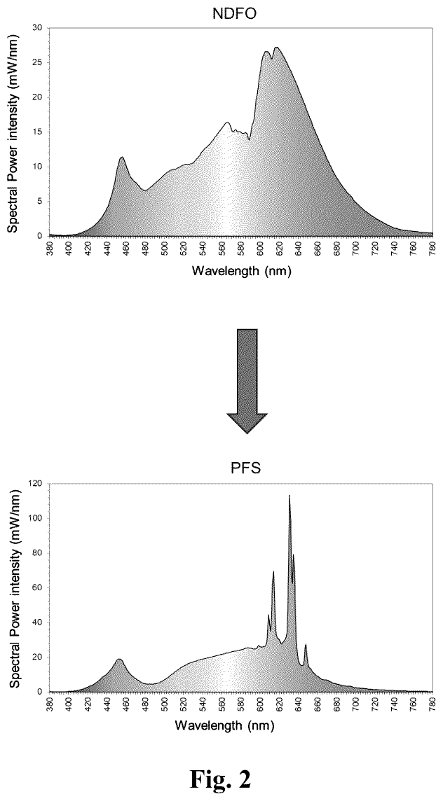

As shown in FIG. 2, compared with an existing lighting source formed from NdFO powder (located in the upper portion of FIG. 2). the spectral features of the lighting source (located in the lower portion of FIG. 2) of the present disclosure are significantly enhanced.

In another embodiment of the present disclosure, the lighting source comprises a light-emitting diode and a fluorescent gel for packaging the light-emitting diode, the fluorescent gel comprising a phosphor and a silica gel composition mixed with the phosphor; wherein an excitation light source is a blue light chip, and an emission wavelength of the blue light chip is 420 nm to 480 nm; the phosphor comprises at least one red phosphor with full width at half maximum (FWMH) of less than 60 nm; and the phosphor comprises at least one yellow or yellow-green phosphor having an emission peak wavelength of 520 nm to 545 nm.

The weight ratio of the narrow-band red phosphor NBR to the broad-band red phosphor BBR is greater than 4:1; and the peak emission wavelength of the yellow or yellow-green phosphor is in the range of 525 nm to 545 nm, and the peak emission wavelength of the broad-band red phosphor is in the range of 600 nm to 640 nm.

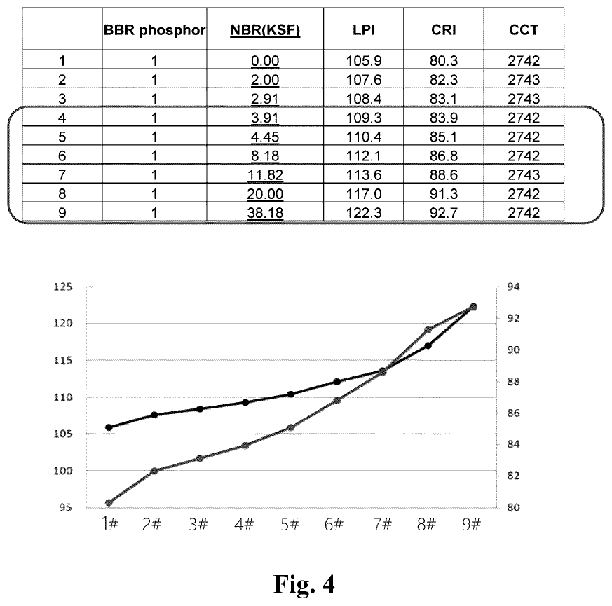

As shown in FIG. 4, in the upper table and the lower line chart, in cases where the weight ratio of the narrow-band red phosphor NBR to the broad-band red phosphor BBR is greater than 4:1, when the peak emission wavelength of the broad-band red phosphor BBR is within the range of 600 nm to 640 nm, the LPI gradually increases. However, the color rendering index (CRI) tends to be decreasing.

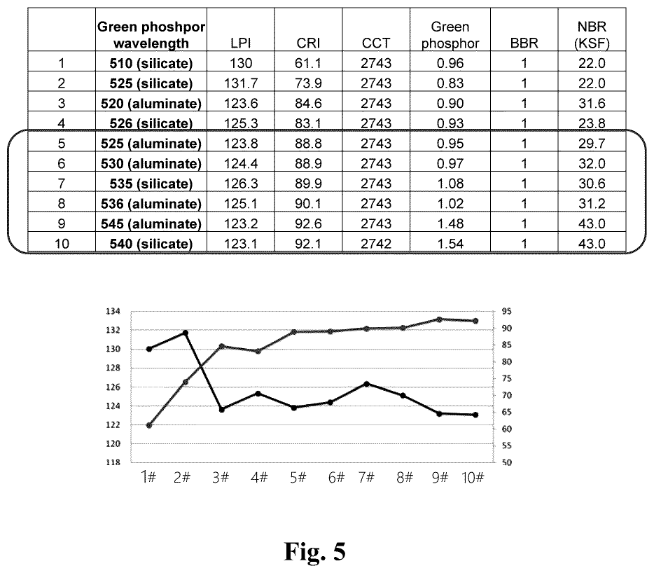

As shown in FIG. 5, in the upper table and the lower line chart, in cases where the weight ratio of the narrow-band red phosphor NBR to the broad-band red phosphor BBR is greater than 4:1, when the peak emission wavelength of the yellow or yellow-green phosphor is within the range of 525 nm to 545 nm, the LPI remains substantially unchanged, but the CRI gradually increases.

Therefore, in this embodiment of the present disclosure, in cases where the weight ratio of the narrow-band red phosphor NBR to the broad-band red phosphor BBR is greater than 4:1, both the peak emission wavelength of the yellow or yellow-green phosphor and the peak emission wavelength of the broad-band red phosphor BBR are defined.

Therefore, this embodiment differs from the previous embodiments in that the peak emission wavelength of the yellow or yellow-green phosphor is defined, thereby further increasing the CRI and the luminous efficacy LPW while ensuring a high LPI.

The yellow or yellow-green phosphor comprises silicate or aluminate. The LPI of yellow or yellow-green phosphor comprising silicate is higher than that of yellow or yellow-green phosphor comprising aluminate, but the reliability (e.g. color degradation and drift) thereof is lower than that of yellow or yellow-green phosphor comprising aluminate.

Specifically, a combination of a blue chip, aluminate YAG, a broad-band red phosphor BBR and a narrow-band red phosphor NBR, a combination of a blue chip, aluminate LAG/GAL, a broad-band red phosphor BBR and a narrow-band red phosphor NBR, or a combination of a blue chip, a silicate, a broad-band red phosphor BBR and a narrow-band red phosphor NBR may all achieve high LPI, CRI, and luminous efficacy LPW.

Because the wavelength of the blue chip has a small effect on the color quality of the lighting source, no more introduction will be given in the present disclosure.

The lighting sources provided by the embodiments of the present disclosure achieve the technical effects of enhanced color preference, high luminous efficacy, and low cost by using the narrow-band red phosphor and limiting the wavelength of the yellow or yellow-green phosphor and the wavelength of the broad-band red phosphor. In particular, the lighting source of the present disclosure increases the LPI value by improving the color appearance.

Compared with existing lighting sources formed from NdFO powder, the lighting source of the present disclosure has significant increase in all aspects of lumens, LPW, CRI, and LPI.

Embodiments of the present disclosure provide a technical solution of a lighting source using an optimized phosphor recipe, so as to at least solve the technical problems of low lighting preference index, low luminous efficacy and high cost in the prior art, thereby achieving the technical effects of enhanced color preference, high luminous efficacy and low cost.

In the embodiments of the present disclosure, the illustration of each embodiment has its own emphasis. For the part not detailed in a certain embodiment, please refer to the relevant illustration in other embodiments.

In the several embodiments provided in the present disclosure, it should be understood that the disclosed technical content may be implemented in other manners.

The content above only relates to preferred embodiments of the present disclosure. It should be noted that for a person of ordinary skill in the art, several improvements and modifications can also be made without departing from the principle of the present disclosure, and these improvements and modifications shall also be considered as within the scope of protection of the present disclosure.

1. A lighting source, comprising a light-emitting diode and a fluorescent gel for packaging the light-emitting diode, the fluorescent gel comprising a phosphor and a silica gel composition mixed with the phosphor, wherein:
the light-emitting diode is a blue light chip, and an emission wavelength of the blue light chip is 420 nm to 480 nm;
the phosphor comprises a first red phosphor with a full width at half maximum of less than 60 nm and a second red phosphor with a full width at half maximum of more than 60 nm, wherein the weight ratio of the first red phosphor to the second red phosphor is greater than 4:1; and
the phosphor further comprises at least one yellow or yellow-green phosphor.

2. The lighting source according to claim 1, wherein the lighting preference index of the lighting source is at least 110, and the color rendering index thereof is at least 80.

3. The lighting source according to claim 1, wherein the first red phosphor comprises manganese-doped potassium fluorosilicate, and the second red phosphor comprises nitride red powder.

4. The lighting source according to claim 1, wherein the yellow or yellow-green phosphor comprises aluminate-series yellow phosphor and yellow-green phosphor and silicate-series yellow phosphor and yellow-green phosphor.

5. The lighting source according to claim 1, wherein the emission peak wavelength of the yellow or yellow-green phosphor is 520 nm to 545 nm.

6. The lighting source according to claim 1, wherein the lighting source has a correlated color temperature in a range of 2500K to 3200K.

7. A lighting source, comprising a light-emitting diode and a fluorescent gel for packaging the light-emitting diode, the fluorescent gel comprising a phosphor and a silica gel composition mixed with the phosphor, wherein:
the light-emitting diode is a blue light chip, and an emission wavelength of the blue light chip is 420 nm to 480 nm;
the phosphor comprises at least one red phosphor with full width at half maximum of less than 60 nm; and
the phosphor comprises at least one yellow or yellow-green phosphor having an emission peak wavelength of 520 nm to 545 nm.

8. The lighting source according to claim 7, wherein the lighting preference index of the lighting source is at least 110, and the color rendering index thereof is at least 80.

9. The lighting source according to claim 7, wherein the red phosphor comprises manganese-doped potassium fluorosilicate.

10. The lighting source according to claim 7, wherein the yellow or yellow-green phosphor comprises aluminate-series yellow or yellow-green phosphor and silicate-series yellow or yellow-green phosphor.

11. The lighting source according to claim 7, wherein the lighting source has a correlated color temperature in a range of 2500K to 3200K.

12. A lighting device, comprising the lighting source according to claim 1.

13. The lighting device according to claim 12, wherein the lighting device is of a lamp bead type or a filament type.
